(19) United States
(12) Patent Application Publication
(10) Pub. No.: US 2023/0316667 A1
(43) Pub. Date: Oct. 5, 2023

(54) INFORMATION PROCESSING APPARATUS, NON-TRANSITORY COMPUTER READABLE MEDIUM STORING INFORMATION PROCESSING PROGRAM, AND INFORMATION PROCESSING METHOD

(71) Applicant: FUJIFILM Business Innovation Corp., Tokyo (JP)

(72) Inventor: Yuki YAMANAKA, Kanagawa (JP)

(73) Assignee: FUJIFILM Business Innovation Corp., Tokyo (JP)

(21) Appl. No.: 17/862,373

(22) Filed: Jul. 11, 2022

(30) Foreign Application Priority Data
Mar. 16, 2022 (JP) 2022-041320

(51) Int. Cl. G06F 3/01; G06F 3/12; G06T 19/00

(52) U.S. Cl. CPC G06T 19/006; G06F 3/013; G06F 3/1206; G06F 3/1271

(57) ABSTRACT

An information processing apparatus includes a processor configured to: in a case where a print instruction of a printed matter is issued to an image forming apparatus from an instruction apparatus, acquire superimposed information virtually superimposed and displayed on the printed matter; and in a case where it is detected that the printed matter is printed by the image forming apparatus, perform control to store the superimposed information in a storage unit in association with the printed matter.

### CROSS REFERENCE TO RELATED APPLICATIONS

This application is based on and claims priority under 35 USC 119 from Japanese Patent Application No. 2022-041320 filed Mar. 16, 2022.

### BACKGROUND

### (I) Technical Field

The present disclosure relates to an information processing apparatus, a non-transitory computer readable medium storing an information processing program, and an information processing method.

### (II) Related Art

JP2017-49847A discloses an information processing apparatus for the purpose of appropriately determining an object viewed by a user among a plurality of objects so that extended information can be presented.

The information processing apparatus detects a plurality of objects from a captured image, determines an object of interest from the plurality of objects, acquires positions of the plurality of objects and angles with respect to a reference, and superimposes and displays an image of extended information related to a reference object on an image of the reference object with respect to a reference object of which a position and angle with respect to the object of interest satisfy a predetermined condition among the plurality of objects.

### SUMMARY

However, in the technique disclosed in JP2017-49847A, there is a problem that a target object is a specific marker or a text string and requires special printing.

Aspects of non-limiting embodiments of the present disclosure relate to an information processing apparatus, a non-transitory computer readable medium storing an information processing program, and an information processing method that is capable of virtually superimposing and displaying related information on a printed matter without requiring special printing.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided the information processing apparatus includes a processor configured to: in a case where a print instruction of a printed matter is issued to an image forming apparatus from an instruction apparatus, acquire superimposed information virtually superimposed and displayed on the printed matter; and in a case where it is detected that the printed matter is printed by the image forming apparatus, perform control to store the superimposed information in a storage unit in association with the printed matter in order to achieve the above object.

### BRIEF DESCRIPTION OF THE DRAWINGS

Exemplary embodiment(s) of the present invention will be described in detail based on the following figures, wherein:

FIG. 1 is a block diagram showing an example of a configuration of an information processing system according to a first exemplary embodiment;

FIG. 2 is a block diagram showing an example of a hardware configuration of a server according to an exemplary embodiment;

FIG. 3 is a block diagram showing an example of a hardware configuration of a terminal apparatus according to an exemplary embodiment;

FIG. 4 is a block diagram showing an example of a hardware configuration of a control unit in an image forming apparatus according to an exemplary embodiment;

FIG. 5 is a block diagram showing an example of a hardware configuration of a control unit in an AR glass according to an exemplary embodiment;

FIG. 6 is a block diagram showing an example of a functional configuration of a server according to an exemplary embodiment;

FIG. 7 is a schematic diagram showing an example of a configuration of a management information database according to an exemplary embodiment;

FIG. 8 is a schematic diagram showing an example of a configuration of an association information database according to an exemplary embodiment;

FIG. 9 is a flowchart showing an example of print instruction processing according to an exemplary embodiment;

FIG. 10 is a front view showing an example of a print instruction screen according to an exemplary embodiment;

FIG. 11 is a flowchart showing an example of information processing according to an exemplary embodiment;

FIG. 12 is a flowchart showing an example of print processing according to an exemplary embodiment;

FIG. 13 is a flowchart showing an example of tracking processing according to an exemplary embodiment;

FIG. 14 is a perspective view showing an example of an AR image according to an exemplary embodiment;

FIG. 15 is a perspective view showing another example of an AR image according to an exemplary embodiment;

FIG. 16 is a block diagram showing an example of a configuration of an information processing system according to a second exemplary embodiment; and

FIG. 17 is a block diagram showing an example of a functional configuration of a server according to a second exemplary embodiment.

### DETAILED DESCRIPTION

Hereinafter, exemplary embodiments of the present disclosure will be described in detail with reference to the drawings. In the present exemplary embodiment, an example of a form in which a technique of the present disclosure is applied to an image forming apparatus provided in an office will be described. However, a subject of the technique of the present disclosure is not limited to the office, but may be any place where an image forming apparatus can be installed, such as a school or a home.

### First Exemplary Embodiment

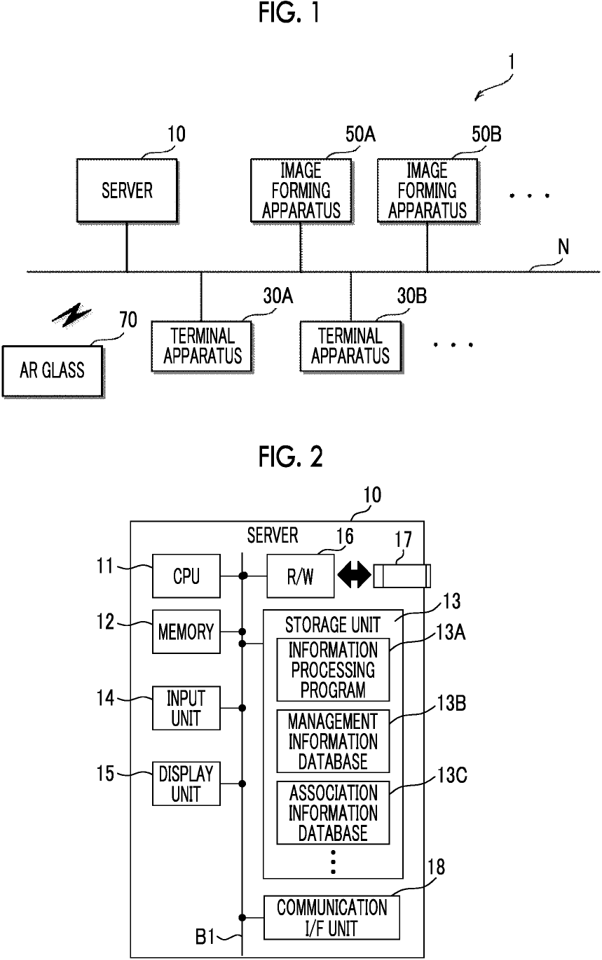

First, a configuration of an information processing system 1 according to the present exemplary embodiment will be described with reference to FIG. 1. In the present exemplary embodiment, a case where the technique of the present disclosure is configured to include a server as an information processing apparatus of the technique of the present disclosure, a terminal apparatus that instructs execution of printing, an image forming apparatus that performs the printing, and an AR glass, and applied to an information processing system that realizes an AR environment will be described. FIG. 1 is a block diagram showing an example of a configuration of the information processing system 1 according to the present exemplary embodiment.

As shown in FIG. 1, the information processing system 1 according to the present exemplary embodiment includes a server 10, a plurality of terminal apparatuses 30A, 30B, ..., a plurality of image forming apparatuses 50A, 50B, ..., and an AR glass 70. In the following, the terminal apparatuses 30A, 30B, ... are simply collectively referred to as “terminal apparatus 30” in a case where the terminal apparatuses 30A, 30B, ... are described without distinction. Further, in the following, the image forming apparatuses 50A, 50B, ... are simply collectively referred to as “image forming apparatus 50” in a case where the image forming apparatuses 50A, 50B, ... are described without distinction.

Examples of a server 10 and the terminal apparatus 30 include an information processing apparatus such as a personal computer and a server computer. Further, in the present exemplary embodiment, as the image forming apparatus 50, a digital multifunction device having an image printing function, an image reading function, an image transmission function, and the like is applied. However, the present invention is not limited to this form, and a form may be adopted in which another image forming apparatus such as an image forming apparatus having only an image printing function or an image forming apparatus having only an image printing function and an image reading function is applied as the image forming apparatus 50.

Not all the image forming apparatuses 50A, 50B, ... have the identical specifications, and it goes without saying that services that can be executed may differ, items that can be set for the services may differ, and optional items that are equipped may differ.

The server 10, the terminal apparatus 30, the image forming apparatus 50, and the AR glass 70 are coupled to each other via a network N, and the server 10 can communicate with the terminal apparatus 30, the image forming apparatus 50, and the AR glass 70 via the network N.

In the present exemplary embodiment, as the network N, a combination of a public communication line such as the Internet or a telephone line network and a communication line in a company such as a local area network (LAN) or a wide area network (WAN) is applied, but the network N is not limited to this form. For example, as the network N, a form may be adopted in which only one of the above-described public communication line and the communication line in the company is applied. Further, in the present exemplary embodiment, wired and wireless communication lines are applied as the network N, but the present invention is not limited to this form, and a form may be adopted in which only one of the wireless communication line and the wired communication line is applied.

Next, the configuration of the server 10 according to the present exemplary embodiment will be described with reference to FIG. 2. FIG. 2 is a block diagram showing an example of a hardware configuration of the server 10 according to the present exemplary embodiment.

As shown in FIG. 2, the server 10 according to the present exemplary embodiment includes a central processing unit (CPU) 11 as a processor, a memory 12 as a temporary storage area, a non-volatile storage unit 13, an input unit 14 such as a keyboard and a mouse, a display unit 15 such as a liquid crystal display, a medium reading/writing apparatus (R/W) 16, and a communication interface (I/F) unit 18. The CPU 11, the memory 12, the storage unit 13, the input unit 14, the display unit 15, the medium reading/writing apparatus 16, and the communication I/F unit 18 are coupled to each other via a bus B1. The medium reading/writing apparatus 16 scans information written in the recording medium 17 and writes information to the recording medium 17.

The storage unit 13 according to the present exemplary embodiment is realized by a hard disk drive (HDD), a solid state drive (SSD), a flash memory, or the like. An information processing program 13A is stored in the storage unit 13 as a storage medium. In the information processing program 13A, the recording medium 17 in which the information processing program 13A is written is coupled to the medium reading/writing apparatus 16, and by scanning the information processing program 13A from the recording medium 17, the medium reading/writing apparatus 16 stores (installs) the information processing program 13A in the storage unit 13. The CPU 11 scans the information processing program 13A from the storage unit 13, expands the information processing program 13A into the memory 12, and sequentially executes processes included in the information processing program 13A.

Further, a management information database 13B and an association information database 13C are stored in the storage unit 13. The details of the management information database 13B and the association information database 13C will be described later.

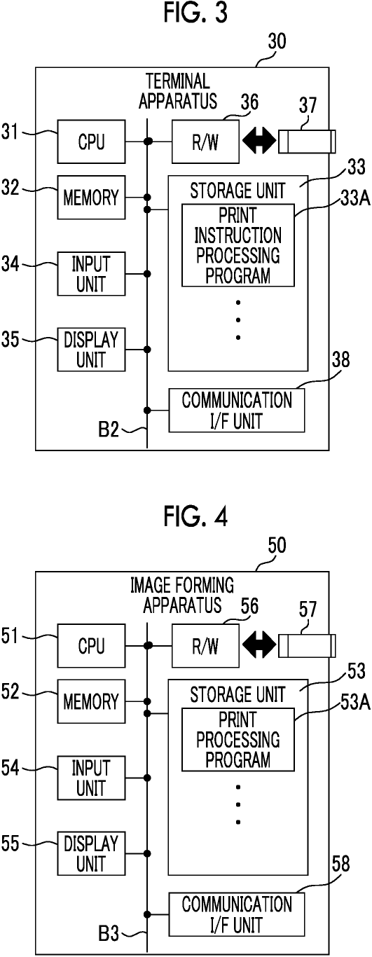

Next, the configuration of the terminal apparatus 30 according to the present exemplary embodiment will be described with reference to FIG. 3. FIG. 3 is a block diagram showing an example of a hardware configuration of the terminal apparatus 30 according to the present exemplary embodiment.

As shown in FIG. 3, the terminal apparatus 30 according to the present exemplary embodiment includes a CPU 31 as a processor, a memory 32 as a temporary storage area, a non-volatile storage unit 33, an input unit 34 such as a keyboard and a mouse, a display unit 35 such as a liquid crystal display, a medium reading/writing apparatus (R/W) 36, and a communication I/F unit 38. The CPU 31, the memory 32, the storage unit 33, the input unit 34, the display unit 35, the medium reading/writing apparatus 36, and the communication I/F unit 38 are coupled to each other via a bus B2. The medium reading/writing apparatus 36 scans the information written in the recording medium 37 and writes information to the recording medium 37.

The storage unit 33 according to the present exemplary embodiment is realized by an HDD, SSD, flash memory, or the like. A print instruction processing program 33A is stored in the storage unit 33 as a storage medium. The recording medium 37 in which the print instruction processing program 33A is written is coupled to the medium reading/writing apparatus 36, and the medium reading/writing apparatus 36 scans the print instruction processing program 33A from the recording medium 37 so that the print instruction processing program 33A is stored (installed) in the storage unit 33. The CPU 31 scans the print instruction processing program 33A from the storage unit 33, expands the print instruction processing program 33A into the memory 32, and sequentially executes processes included in the print instruction processing program 33A.

Next, with reference to FIG. 4, the configuration of the control unit in the image forming apparatus 50 according to the present exemplary embodiment will be described. FIG. 4 is a block diagram showing an example of the hardware configuration of the control unit in the image forming apparatus 50 according to the present exemplary embodiment.

As shown in FIG. 4, the image forming apparatus 50 according to the present exemplary embodiment includes a CPU 51 as a processor, a memory 52 as a temporary storage area, a non-volatile storage unit 53, an input unit 54 such as a touch panel, a display unit 55 such as a liquid crystal display, a medium reading/writing apparatus (R/W) 56, and a communication I/F unit 58. The CPU 51, the memory 52, the storage unit 53, the input unit 54, the display unit 55, the medium reading/writing apparatus 56, and the communication I/F unit 58 are coupled to each other via a bus B3. The medium reading/writing apparatus 56 scans the information written in the recording medium 57 and writes information to the recording medium 57.

The storage unit 53 according to the present exemplary embodiment is realized by an HDD, SSD, flash memory, or the like. A print processing program 53A is stored in the storage unit 53 as a storage medium. The recording medium 57 in which the print processing program 53A is written is coupled to the medium reading/writing apparatus 56, and the medium reading/writing apparatus 56 scans the print processing program 53A from the recording medium 57, so that the print processing program 53A is stored (installed) in the storage unit 53. The CPU 51 scans the print processing program 53A from the storage unit 53, expands the print processing program 53A into the memory 52, and sequentially executes processes included in the print processing program 53A.

Needless to say, the image forming apparatus 50 is provided with various image-related processing units such as an image forming engine, an image reading unit, an image transmitting unit, and the like, in addition to the above-described configuration of the control unit.

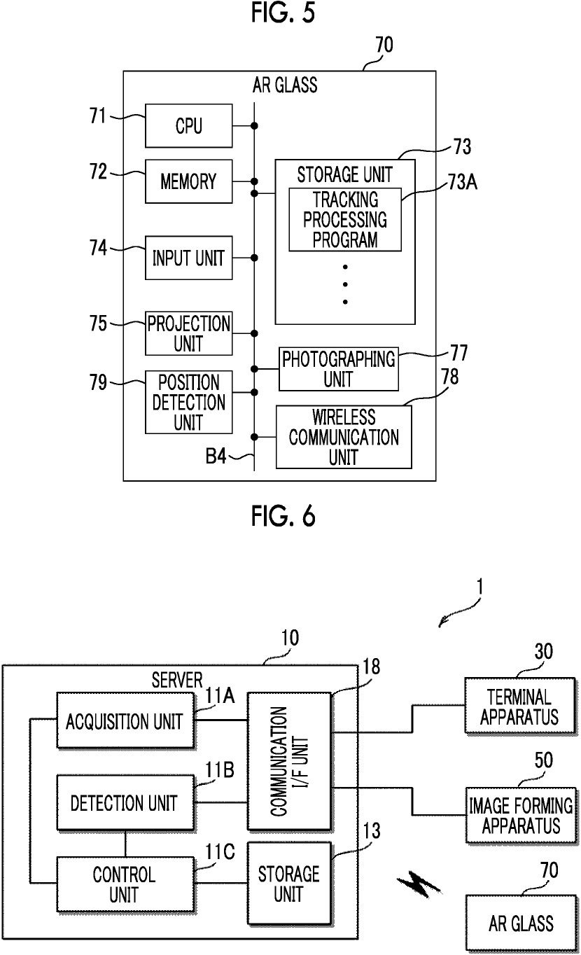

Next, with reference to FIG. 5, the configuration of the control unit in the AR glass 70 according to the present exemplary embodiment will be described. FIG. 5 is a block diagram showing an example of a hardware configuration of a control unit in the AR glass 70 according to the present exemplary embodiment.

As shown in FIG. 5, the AR glass 70 according to the present exemplary embodiment includes a CPU 71 as a processor, a memory 72 as a temporary storage area, a non-volatile storage unit 73, an input unit 74 such as a micro switch, a projection unit 75 that projects various kinds of information, and a wireless communication unit 78. Further, the AR glass 70 according to the present exemplary embodiment includes a photographing unit 77 and a position detection unit 79. The CPU 71, the memory 72, the storage unit 73, the input unit 74, the projection unit 75, the photographing unit 77, the wireless communication unit 78, and the position detection unit 79 are coupled to each other via a bus B4.

The storage unit 73 according to the present exemplary embodiment is realized by an HDD, SSD, flash memory, or the like. A tracking processing program 73A is stored in the storage unit 73 as a storage medium. In the tracking processing program 73A, the latest version at that time is stored in the storage unit 73 in advance in a manufacturing process of the AR glass 70, and the AR glass 70 is shipped in that state. Then, in a case where the tracking processing program 73A is revised, the AR glass 70 downloads the latest version via the wireless communication unit 78 and updates what is stored in the storage unit 73. The CPU 71 scans the tracking processing program 73A from the storage unit 73, expands the tracking processing program 73A into the memory 72, and sequentially executes processes included in the tracking processing program 73A.

Further, the wireless communication unit 78 according to the present exemplary embodiment can wirelessly communicate with the server 10 via the network N. In the wireless communication unit 78 according to the present exemplary embodiment, a mobile communication standard such as so-called 4G and 5G are applied as a communication standard for communicating with the server 10, but it goes without saying that the communication standard is not limited to these.

Further, the wireless communication unit 78 according to the present exemplary embodiment can directly and wirelessly communicate with the image forming apparatus 50. Therefore, although not shown, the image forming apparatus 50 has a built-in wireless communication unit capable of wireless communication with the wireless communication unit 78 of the AR glass 70. In the wireless communication unit 78 according to the present exemplary embodiment, a standard based on bluetooth low energy (BLE (registered trademark)) is applied as a communication standard for communicating with the image forming apparatus 50, but the standard is not limited to this. For example, in addition to the standard by the BLE, any communication standard can be applied as a standard for communicating with the image forming apparatus 50 as long as it is a standard capable of short-range wireless communication with the image forming apparatus 50 such as the WiFi (registered trademark) standard.

Further, the position detection unit 79 according to the present exemplary embodiment detects the position of the AR glass 70 and outputs position information, and in the present exemplary embodiment, the one using a global positioning system (GPS) is applied, but the present invention is not limited to this form. For example, a form may be adopted in which one that uses position information acquired from a WiFi (registered trademark) router, one that detects a position by using a beacon, one that detects a position by image analysis using a photographed image, and the like is applied as the position detection unit 79.

Further, the photographing unit 77 according to the present exemplary embodiment photographs a moving image, and outputs the image information obtained by the photographing.

Although not shown, it goes without saying that the AR glass 70 is provided with a lens for both eyes and other components for realizing a function as spectacles such as a spectacle frame. The projection unit 75 according to the present exemplary embodiment is supposed to directly project various kinds of information onto the lens. As described above, in the AR glass 70 according to the present exemplary embodiment, various kinds of information is supposed to be displayed by projection by the projection unit 75, but the present invention is not limited to this. For example, a form may be adopted in which, instead of the projection unit 75, a dedicated display for displaying various information in a state that can be visually recognized by a wearer is provided, and various kinds of information is displayed by the display.

Further, although not shown in the drawing for avoiding confusion, in the information processing system 1 according to the present exemplary embodiment, the AR glass 70 is prepared for each user of the terminal apparatus 30.

Next, with reference to FIG. 6, the functional configuration of the server 10 according to the present exemplary embodiment will be described. FIG. 6 is a block diagram showing an example of the functional configuration of the server 10 according to the present exemplary embodiment.

As shown in FIG. 6, the server 10 includes an acquisition unit 11A, a detection unit 11B, and a control unit 11C. In a case where the CPU 11 of the server 10 executes the information processing program 13A, the CPU functions as the acquisition unit 11A, the detection unit 11B, and the control unit 11C.

In a case where a print instruction of a printed matter is given to the image forming apparatus 50 from an instruction apparatus (terminal apparatus 30 in the present exemplary embodiment), the acquisition unit 11A according to the present exemplary embodiment acquires superimposed information to be virtually superimposed and displayed on the printed matter from the terminal apparatus 30 and the AR glass 70. In the present exemplary embodiment, five types of a title, an author, a creation date, a content, and a thumbnail of the printed matter are applied as the superimposed information, but the present invention is not limited to this. A form may be adopted in which one type of these information, or a combination of two or more types and four or less types is applied as the superimposed information, and a form may be adopted in which, in addition to the above five types of information, other information such as a user of a printed matter, a storage destination of a printed matter, and a storage period of a printed matter is applied as the superimposed information.

Further, the detection unit 11B according to the present exemplary embodiment detects that the printed matter is printed by detecting that the printed matter is separated from the image forming apparatus 50. In the present exemplary embodiment, the detection unit 11B detects that the printed matter is separated from the image forming apparatus 50 by detecting that a line of sight of a printing person of the printed matter is directed at the printed matter. That is, the AR glass 70 according to the present exemplary embodiment is equipped with a line-of-sight detection function of detecting a direction of the line of sight of a wearer, and the detection unit 11B according to the present exemplary embodiment is supposed to detect that the printed matter is separated from the image forming apparatus 50 by using the line-of-sight detection function of the AR glass 70. However, the method of detecting that the printed matter is separated from the image forming apparatus 50 is not limited to this. In a case where the image forming apparatus 50 is an apparatus in which a discharge destination of the printed matter that is printed is inside the body and a discharge portion is illuminated until the printed matter discharged in the body is taken out, a form may be adopted in which it is detected that the printed matter is separated by detecting that light of the illumination is turned off. Further, a form may be adopted in which a paper sensor is provided at the discharge portion of the printed matter in the image forming apparatus 50, and the paper sensor is used to detect that the printed matter is separated.

Then, in a case where the detection unit 11B detects that the printed matter is printed by the image forming apparatus 50, the control unit 11C according to the present exemplary embodiment controls to associate the superimposed information with the printed matter and store the information in the storage unit 13.

In the present exemplary embodiment, the acquisition unit 11A acquires each piece of information of the title, author, and creation date of the printed matter in the superimposed information by extracting each information from print job information used for printing the printed matter. Further, in the present exemplary embodiment, the acquisition unit 11A acquires the content of the printed matter in the superimposed information by extracting the content from text information in a case where the printed matter is text information. Further, in the present exemplary embodiment, the acquisition unit 11A acquires thumbnails in the superimposed information by extracting the thumbnails from attribute information of an electronic file on the premise that the electronic file of the printed matter is in PDF format. However, the method of acquiring the superimposed information by the acquisition unit 11A is not limited to the above method, and for example, a form may be adopted in which the superimposed information is acquired by having an instructor instructed to print the printed matter input the superimposed information. Further, in a case where the electronic file of the printed matter is an image file, a form may be adopted in which the superimposed information is acquired by using a known optical character recognition (OCR) technique in the related art.

By the way, in a case of printing one sheet of printed matter at a time by the image forming apparatus 50, it is sufficient to associate the superimposed information only with the one sheet of printed matter. However, in a case where a plurality of sheets of printed matter are printed at one time and the plurality of sheets of printed matter are overlapped, in a case where individual superimposed information can be collectively associated with each of the printed matters, convenience for the user will be remarkably improved.

Therefore, in a case where a plurality of sheets of printed matter are printed and the printed plurality of sheets of printed matter are overlapped, the control unit 11C according to the present exemplary embodiment performs control to create integrated information in which superimposed information corresponding to each of the plurality of sheets of printed matter is integrated and to store the integrated information in the storage unit 13 in association with the plurality of sheets of printed matter collectively.

Further, in a case where the acquisition unit 11A according to the present exemplary embodiment detects that the printed matter is printed by the image forming apparatus 50, the acquisition unit 11A acquires the printing person information indicating a printing person who performed the printing from the image forming apparatus 50. Then, the control unit 11C according to the present exemplary embodiment specifies superimposed information to be superimposed on the printed matter by using the printing person information acquired by the acquisition unit 11A.

In the present exemplary embodiment, the image forming apparatus 50 performs login authentication of the printing person prior to execute printing the printed matter, and the information that can specify the printing person (in the present exemplary embodiment, a user ID (identification) described later), which is used when the login authentication is performed, is applied as the printing person information, but it goes without saying that the information is not limited to this.

The printed matter to which the superimposed information is associated by the control unit 11C according to the present exemplary embodiment is displayed in a state in which the superimposed information is virtually superimposed when the user refers to the printed matter via the AR glass 70. At this time, a form may be adopted in which it is possible to selectively apply whether the superimposed information is always displayed or displayed only in a case where a predetermined condition is satisfied. Examples of the predetermined conditions in this form include a condition that the user’s line of sight is directed to the target printed matter, a condition that a predetermined operation is performed on the input unit 74, and the like.

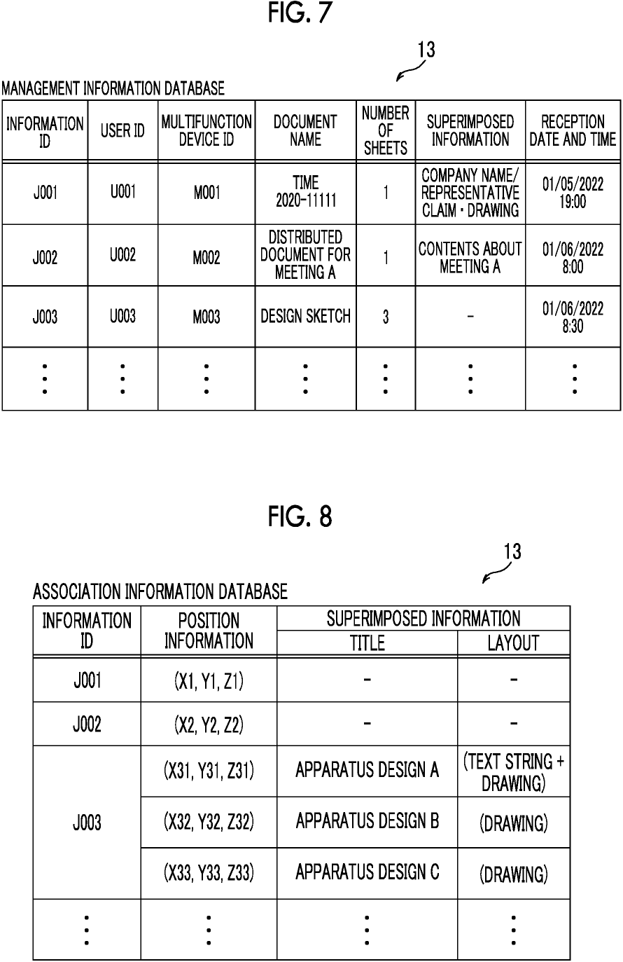

Next, the management information database 13B according to the present exemplary embodiment will be described with reference to FIG. 7. FIG. 7 is a schematic diagram showing an example of a configuration of the management information database 13B according to the present exemplary embodiment.

The management information database 13B according to the present exemplary embodiment is a database in which information related to the printed matter printed by the image forming apparatus 50 and information related to superimposed information that is virtually superimposed and displayed on the printed matter in a case where the printed matter is one sheet are registered. As shown in FIG. 7 as an example, the management information database 13B according to the present exemplary embodiment stores each piece of information of an information ID, a user ID, a multifunction device ID, a document name, the number of sheets, superimposed information, and a reception date and time in association with each other.

The information ID is information individually assigned to each printed matter in order to identify the corresponding printed matter, and the user ID is information individually assigned to each user in order to identify the user who has instructed to print the corresponding printed matter. Further, the multifunction device ID is information individually assigned to each image forming apparatus 50 in order to identify the image forming apparatus 50 that prints the corresponding printed matter, and the document name is information indicating the name of document that is the corresponding printed matter. The number of sheets is information indicating the number of printed sheets of the corresponding printed matter, the superimposed information is information indicating the superimposed information that is virtually superimposed and displayed on the corresponding printed matter, and the reception date and time is information indicating the date and time when the corresponding superimposed information or the like is received from the terminal apparatus 30.

In the example shown in FIG. 7, according to the instruction from the user to which “U001” is assigned as the user ID, it is shown that the image forming apparatus 50 to which “M001” is assigned as the multifunction device ID prints the printed matter to which “J001” is assigned as the information ID. Further, in the example shown in FIG. 7, the name of the document to be printed matter is “JP ...”, and it is shown that only one sheet is printed and that superimposed information such as a company name is virtually superimposed and displayed on the printed matter.

Next, the association information database 13C according to the present exemplary embodiment will be described with reference to FIG. 8. FIG. 8 is a schematic diagram showing an example of the configuration of the association information database 13C according to the present exemplary embodiment.

The association information database 13C according to the present exemplary embodiment is a database in which information for associating a position of the printed matter printed by the image forming apparatus 50 with the superimposed information virtually superimposed on the printed matter is registered. As shown in FIG. 8 as an example, the association information database 13C according to the present exemplary embodiment stores each piece of information of the information ID, the position information, and the superimposed information in association with each other.

The information ID is the identical information (information indicating a printed matter) as the information ID of the management information database 13B, and the position information is information indicating a coordinate position of the corresponding printed matter with a predetermined position as an origin in a three-dimensional space. The superimposed information is information that is virtually superimposed and displayed on each printed matter in a case where the corresponding printed matter is a plurality of sheets.

That is, in the information processing system 1 according to the present exemplary embodiment, in a case where one sheet of printed matter is printed by the image forming apparatus 50, the user who has printed the printed matter directs the line of sight at the printed matter in a state of wearing the AR glass 70. In response to this, the AR glass 70 specifies the position of the printed matter by using the above-described line-of-sight detection function and a known image recognition technique in the related art. Specifically, the AR glass 70 detects a direction of a line of sight of the user by the line-of-sight detection function, assumes that an object that exists in the direction of the detected line of sight and that matches the characteristic of the printed matter is the printed matter, and detects the printed matter from the image information obtained by the photographing unit 77 by the image recognition technique. Then, the AR glass 70 continuously tracks the detected printed matter, and sequentially transmits the position information indicating the coordinate position in the three-dimensional space of the printed matter sequentially obtained by the tracking to the server 10. The server 10 sequentially stores (updates) the position information received from the AR glass 70 in the association information database 13C as the position information of the corresponding printed matter.

Further, in the information processing system 1 according to the present exemplary embodiment, in a case where a plurality of sheets of printed matter are printed by the image forming apparatus 50, the user who has printed the printed matter is supposed to pick up the plurality of sheets of printed matter by hands in a state of wearing the AR glass 70 and confirm the content of each printed matter one by one. In response to this, similar to the case where only one sheet is printed, the AR glass 70 detects the position of each printed matter by using the line-of-sight detection function and the image recognition technique, and then continuously tracks each of the detected printed matters, and sequentially transmits the position information indicating the coordinate position in the three-dimensional space of each printed matter sequentially obtained by the tracking to the server 10. The server 10 sequentially stores (updates) the position information received from the AR glass 70 in the association information database 13C as the position information of the corresponding printed matter.

Further, in a case where a plurality of sheets of printed matter are printed by the image forming apparatus 50, the AR glass 70 acquires the title and layout of each of the detected printed matters by the OCR technique known in the related art or the like, and transmits these pieces of information to the server 10. The server 10 stores each piece of information of the title and the layout received from the AR glass 70 in association with the corresponding printed matter as superimposed information of the association information database 13C.

In the example shown in FIGS. 7 and 8, it is shown that the printed matter to which “J001” is assigned as the information ID exists at a coordinate position (X1, Y1, Z1) at this time point, and the superimposed information virtually superimposed and displayed is a company name or the like. Further, in the example shown in FIG. 8, it is shown that the printed matter to which “J003” is assigned as the information ID is composed of three sheets, a first sheet of printed matter exists at a coordinate position (X31, Y31, Z31) at this time point, and superimposed information virtually superimposed and displayed is “apparatus design A” and “text string + drawing”.

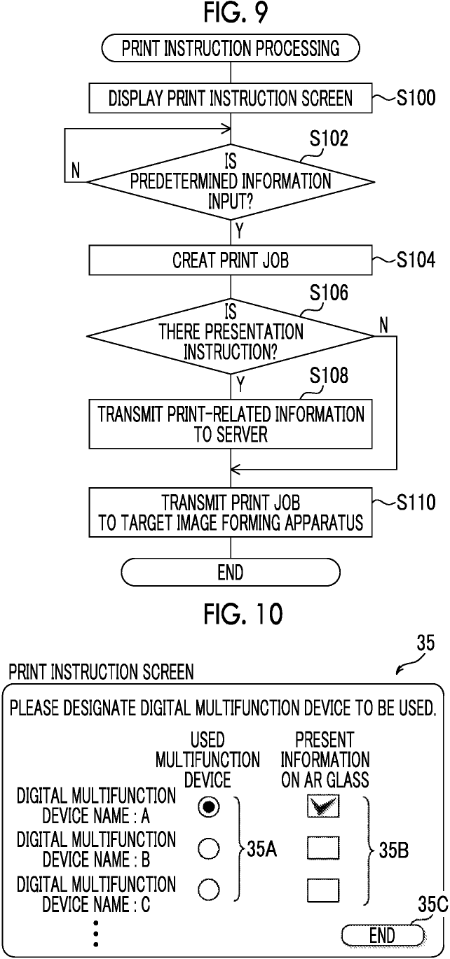

Next, an action of the information processing system 1 according to the present exemplary embodiment will be described with reference to FIGS. 9 to 15.

First, with reference to FIG. 9, an action of the terminal apparatus 30 in a case of executing the print instruction processing will be described. FIG. 9 is a flowchart showing an example of the print instruction processing according to the present exemplary embodiment.

In the information processing system 1 according to the present exemplary embodiment, the user (hereinafter, referred to as “print instructor”) instructs the terminal apparatus 30 to print a target printed matter (hereinafter, referred to as a “target printed matter”) by using the terminal apparatus 30. In a case where the print instructor gives a print instruction, the CPU 31 of the terminal apparatus 30 executes the print instruction processing program 33A, so that the print instruction processing shown in FIG. 9 is executed.

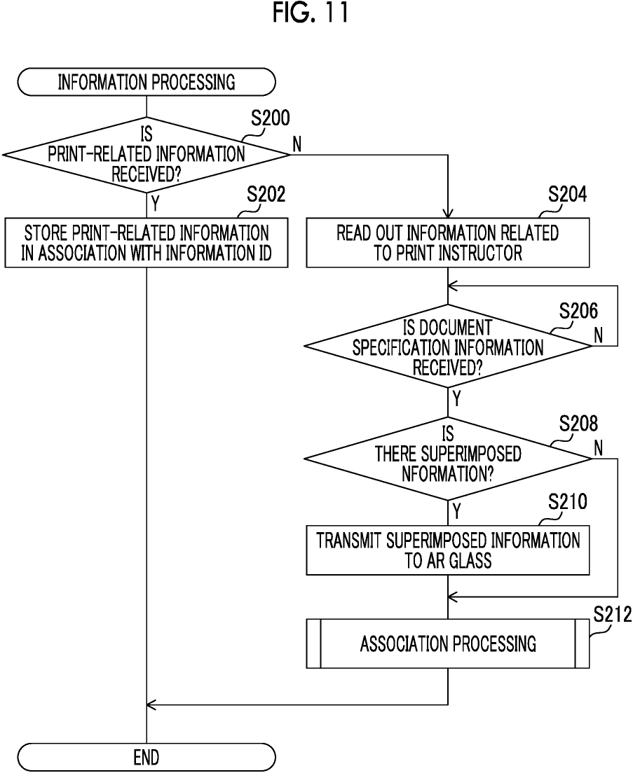

In step S100 of FIG. 9, the CPU 31 controls the display unit 35 so as to display a print instruction screen having a predetermined configuration. In step S102, the CPU 31 waits until predetermined information is input. FIG. 10 shows an example of the print instruction screen according to the present exemplary embodiment.

As shown in FIG. 10, on the print instruction screen according to the present exemplary embodiment, a message prompting designation of an image forming apparatus or the like for printing the target printed matter is displayed. Further, on the print instruction screen according to the present exemplary embodiment, information indicating a name of the image forming apparatus 50 that can be used in the terminal apparatus 30 is displayed. Further, on the print instruction screen according to the present exemplary embodiment, a designated portion 35A for designating the image forming apparatus 50 to be used is displayed, and a designated portion 35B designated in a case where the superimposed information is presented in the AR glass 70, that is, in a case where the superimposed information is virtually superimposed and displayed on the target printed matter is displayed.

In a case where the print instruction screen shown in FIG. 10 is displayed, the print instructor uses the input unit 34 to designate the designated portion 35A corresponding to the image forming apparatus 50 that prints the target printed matter. Further, the print instructor uses the input unit 34 to designate the corresponding designated portion 35B in a case where the superimposed information is virtually superimposed on the target printed matter. Then, in a case where the above designation ends, the print instructor designates an end button 35C by using the input unit 34. In a case where the end button 35C is designated by the print instructor, a positive determination is made in step S102 and the processing proceeds to step S104.

In step S104, the CPU 31 creates print job information for the target printed matter. In step S106, the CPU 31 determines whether the designated portion 35B is designated, and in a case where a negative determination is made, the processing proceeds to step S110, while in a case where a positive determination is made, the processing proceeds to step S108.

In step S108, in a case where the target printed matter is only one sheet, the CPU 31 acquires the superimposed information virtually superimposed on the target printed matter as described above, and transmits the acquired superimposed information to the server 10. Further, the CPU 31 transmits print-related information including a user ID assigned in advance to the print instructor, information indicating the image forming apparatus 50 that prints the target printed matter, information indicating the document name of the target printed matter, and information indicating the number of printed sheets of printed matter of the target printed matter to the server 10. In a case where the server 10 receives the print-related information, the server 10 gives a new information ID to the received information and stores (registers) the information in the management information database 13B.

In step S110, the CPU 31 transmits the created print job information to the image forming apparatus 50 designated by the designated portion 35A, and then ends the present print instruction processing.

Upon receiving the print job information, the image forming apparatus 50 temporarily stores the received print job information, performs login authentication with respect to the print instructor, and then prints the printed matter using the received print job information in response to the instruction by the print instructor.

In the present exemplary embodiment, as described above, the selection designation of the image forming apparatus 50 to be used and whether the superimposed information is virtually superimposed and displayed is performed via a dedicated screen shown in FIG. 10 as an example. However, the present invention is not limited to this. For example, a form may be adopted in which a standard function provided in a browser is used to perform these designations.

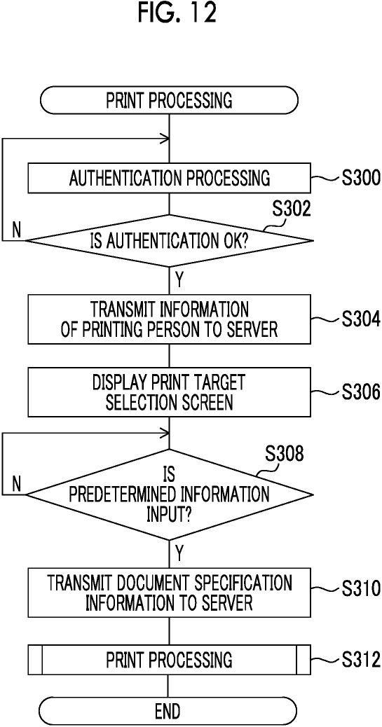

Next, with reference to FIG. 11, the action of the server 10 in a case of executing information processing will be described. FIG. 11 is a flowchart showing an example of the information processing according to the present exemplary embodiment.

In the information processing system 1 according to the present exemplary embodiment, when the target printed matter is printed by the image forming apparatus 50, the information that can specify the print instructor (corresponding to the above-described printing person information, hereinafter referred to as “printing person information”) obtained at the time of the above-described login authentication is transmitted to the server 10. In the information processing according to the present exemplary embodiment, in a case where the printing person information or the print-related information transmitted in the above-described print instruction processing is received, the CPU 11 of the server 10 executes the information processing program 13A to execute the information processing shown in FIG. 11.

In step S200 of FIG. 11, the CPU 11 determines whether the received information is print-related information, and in a case where a positive determination is made, the processing proceeds to step S202.

In step S202, the CPU 11 stores (registers) the received print-related information in the management information database 13B together with the newly generated information ID. In a case where the CPU 11 receives superimposed information together with the print-related information, the CPU 11 also stores (registers) the superimposed information in the management information database 13B in association with the newly generated information ID. Then, in a case where the storage of the above various kinds of information ends, the CPU 11 ends the present information processing. By the processing of step S202, the print-related information and the superimposed information received from each of the terminal apparatuses 30 are sequentially registered in the management information database 13B together with the corresponding information IDs, and the management information database 13B is constructed.

On the other hand, in a case where a negative determination is made in step S200, it is assumed that the received information is the printing person information, and the processing proceeds to step S204.

In step S204, the CPU 11 assumes that the printed matter by the print instructor indicated by the received printing person information is to be printed soon, and scans all pieces of information (hereinafter, referred to as “target candidate information”) stored in association with the user ID of the print instructor from the management information database 13B.

After transmitting the printing person information to the server 10, the image forming apparatus 50 (hereinafter, referred to as “target apparatus”) which is a transmission source of the printing person information transmits document specification information (information ID in the present exemplary embodiment), that is information that can specify the target printed matter designated to be printed by the print instructor, to the server 10.

Therefore, in step S206, the CPU 11 waits until the document specification information is received from the target apparatus. In step S208, the CPU 11 determines whether the superimposed information is associated with the target printed matter specified by the document specification information, and in a case where a negative determination is made, the processing proceeds to step S212, while in a case where a positive determination is made, the processing proceeds to step S210. In step S210, the CPU 11 transmits the superimposed information associated with the target printed matter to the AR glass 70 used by the print instructor.

Although not shown in the present exemplary embodiment, information that can be communicated with the AR glass 70 used is registered in advance for each user of the information processing system 1, and the superimposed information is transmitted to the AR glass 70 used by the print instructor by using the information. However, the present invention is not limited to this. For example, a form may be adopted in which an installation position of each image forming apparatus 50 is registered in advance, and in the position detected by the position detection unit 79 provided on the AR glass 70, it is assumed that the AR glass 70 closest to the target apparatus is the AR glass 70 of the print instructor thereby transmitting the superimposed information to the AR glass 70.

On the other hand, as described above, in a case where the printed matter is detected, the AR glass 70 sequentially transmits the position information indicating the position of the printed matter in the three-dimensional space, which is sequentially obtained by tracking the printed matter, to the server 10. Further, in a case where a plurality of sheets of printed matter are printed, the AR glass 70 transmits information indicating the title and the layout of each printed matter to the server 10.

Therefore, in step S212, the CPU 11 uses the information received from the AR glass 70 to execute the association processing of associating the printed matter that is printed with the corresponding superimposed information, as shown below.

That is, first, in a case where the CPU 11 receives the information indicating the title and the layout of each of the plurality of sheets of printed matter, it is assumed that the plurality of sheets of printed matter are overlapped. Then, the CPU 11 associates the information indicating the title and the layout with the corresponding printed matter, and stores the information in the corresponding storage area of the association information database 13C as the above-described integrated information.

Next, the CPU 11 sequentially stores (updates) the position information sequentially transmitted from the AR glass 70 in the corresponding storage area of the association information database 13C in association with the corresponding printed matter. At this time, the CPU 11 assumes that the corresponding printed matter is the printed matter indicated by the document specification information received by the processing of step S206.

Then, in a case where a predetermined end timing arrives, the CPU 11 ends the association processing by stopping the storage of the position information in the association information database 13C. In a case where the association processing according to step S212 ends, the present information processing ends. In the present exemplary embodiment, as the end timing, a timing at which the reception of the position information from the AR glass 70 is interrupted for a predetermined period (for example, one minute) or more is applied, but the end timing is not limited to this. For example, a form may be adopted in which a timing at which the print instructor removes the AR glass 70 or a timing at which a power switch of the AR glass 70 is turned off is applied as the end timing.

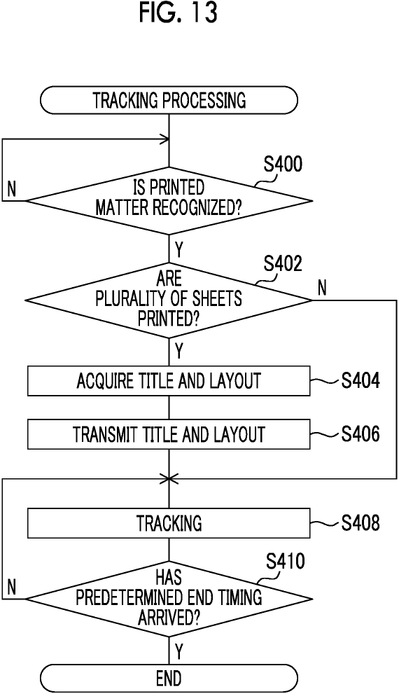

Next, with reference to FIG. 12, the action of the image forming apparatus 50 in a case of executing the print processing will be described. FIG. 12 is a flowchart showing an example of the print processing according to the present exemplary embodiment.

As described above, in the information processing system 1 according to the present exemplary embodiment, the login authentication with respect to the print instructor is performed prior to printing the printed matter in the image forming apparatus 50. Prior to performing the login authentication, the print instructor performs an instruction input instructing the login authentication to be performed via the input unit 54 provided in the image forming apparatus 50. In a case where the instruction input is performed, the CPU 51 of the image forming apparatus 50 executes the print processing program 53A, so that the print processing shown in FIG. 12 is executed.

In step S300 of FIG. 12, the CPU 51 performs processing related to the login authentication with respect to the print instructor described above. In step S302, the CPU 51 determines whether the login authentication is successful, and in a case where a negative determination is made, the processing returns to step S300, while in a case where a positive determination is made, the processing proceeds to step S304. In step S304, the CPU 51 transmits the above-described printing person information to the server 10.

In step S306, the CPU 51 controls the display unit 55 to display a print target selection screen (not shown) that displays information (information indicating the document name of the printed matter in the present exemplary embodiment) indicating the printed matter to be printed by the print job information received from the terminal apparatus 30 used by the print instructor in a list format. In step S308, the CPU 51 waits until predetermined information is input.

In a case where the print target selection screen is displayed, the print instructor designates the document name of the document to be printed from the displayed document names via the input unit 54. In a case where the document name is designated, a positive determination is made in step S308 and the processing proceeds to step S310.

In step S310, the CPU 51 transmits the above-described document specification information to the server 10, and in step S312, the CPU 51 executes printing of the printed matter corresponding to the document name designated by the print instructor, and then ends the present print processing.

Next, with reference to FIG. 13, the action of the AR glass 70 in a case where the tracking processing is executed will be described. FIG. 13 is a flowchart showing an example of the tracking processing according to the present exemplary embodiment.

In a case where the print instructor wears the AR glass 70 and the instruction input to start execution by the print instructor is performed via the input unit 74, the CPU 71 of the AR glass 70 executes the tracking processing program 73A to execute the tracking processing shown in FIG. 13.

In step S400 of FIG. 13, the CPU 71 waits until the printed matter printed by the image forming apparatus 50 is detected as described above.

In step S402, the CPU 71 determines whether a plurality of sheets of printed matter are printed, and in a case where a negative determination is made, the processing proceeds to step S408, while in a case where a positive determination is made, the processing proceeds to step S404. As described above, in a case where a plurality of sheets of printed matter are printed by the image forming apparatus 50, the print instructor picks up the plurality of sheets of printed matter by hands and confirms the content of each printed matter one by one. Therefore, the CPU 71 performs the determination in step S402 by determining whether the confirmation is performed by using the image information obtained by the photographing unit 77.

In step S404, the CPU 71 detects the information indicating the title and layout from the plurality of sheets of printed matter as described above, and in step S406, the CPU 71 transmits the information indicating the detected title and layout to the server 10.

In step S408, the CPU 71 performs the tracking of the detected printed matter as described above, and transmits the position information indicating the position of the printed matter obtained in the tracking to the server 10.

In step S410, the CPU 71 determines whether a predetermined end timing has arrived as the timing to end tracking, and in a case where a negative determination is made, the processing returns to step S408, while in a case where a positive determination is made, the present tracking processing ends. In the present exemplary embodiment, the timing at which the print instructor removes the AR glass 70 is applied as the end timing, but the end timing is not limited to this. For example, a form may be adopted in which a timing at which the print instructor performs a predetermined operation on the AR glass 70 or a timing at which the printed matter disappears from the field of view is applied as the end timing.

The AR glass 70 executes processing of virtually superimposing and displaying the superimposed information corresponding to the printed matter visually recognized through the lens by using the information registered in the association information database 13C by each of the above processing, the received superimposed information, and the like on the printed matter. Therefore, unlike the technique disclosed in JP2017-49847A, it is possible to virtually superimpose and display the related information on the printed matter without requiring special printing such as printing additional information for giving virtual related information on the printed matter.

As described above, in the present exemplary embodiment, the case where the server 10 performs the processing of associating the superimposed information on the actual printed matter has been described, but the present invention is not limited to this. For example, a form may be adopted in which the AR glass 70 performs the processing of performing the association. As a form in this case, a form is exemplified in which the CPU 71 of the AR glass 70 virtually displays the superimposed information received from the server 10 and the superimposed information (each piece of information of the title and the layout) detected by the CPU 71 while storing the superimposed information in the storage unit 73 in association with the printed matter detected by the CPU 71. In this case, the information processing apparatus of the present disclosure is included in the AR glass 70.

FIG. 14 shows a perspective view showing an example of an AR image according to the present exemplary embodiment, which is referred to via the AR glass 70 in a case where the superimposed information is associated with only one sheet of printed matter. In FIG. 14, in order to avoid confusion, drawing is omitted for a background and an image of the content of the printed matter, except for a printed matter 90 and hands 92 of the print instructor holding the printed matter 90.

As shown in FIG. 14, in the AR image in this case, superimposed information 98A corresponding to the printed matter 90 is displayed in a balloon 96A of which a source is an area of the printed matter 90. Then, even in a case where the printed matter 90 is moved by the print instructor, the balloon 96A is displayed in the identical state following the movement.

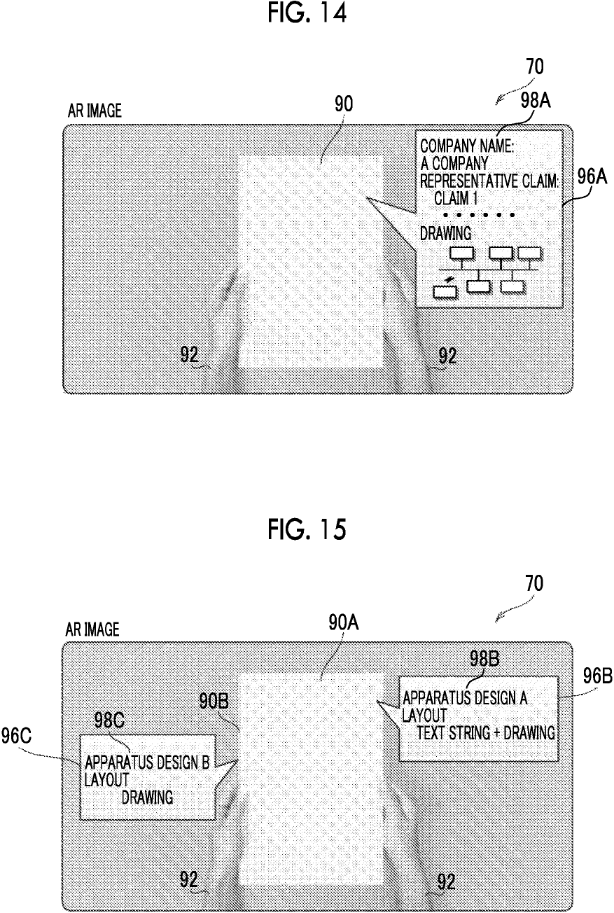

Further, FIG. 15 shows a perspective view showing an example of the AR image according to the present exemplary embodiment, which is referred to via the AR glass 70 in a case where the superimposed information is associated with a plurality of sheets of printed matter (two in the example shown in FIG. 15). Also in FIG. 15, in order to avoid confusion, drawing is omitted for the background and the image of the content of the printed matter except for printed matters 90A and 90B and the hands 92 of the print instructor.

As shown in FIG. 15, in the AR image in this case, superimposed information 98B and 98C corresponding to each of the printed matters 90A and 90B are displayed in balloons 96B and 96C of which sources are areas of the corresponding printed matters 90A and 90B, respectively. Even in this case, even in a case where the printed matters 90A and 90B are moved by the print instructor, the balloons 96B and 96C are displayed in the identical state following the movement.

In AR screens shown in FIGS. 14 and 15, the size of the balloon may be variable according to an amount of information to be displayed. In this case, in a case where the balloon is simply enlarged according to the amount of information, it will be difficult to see other objects such as printed matter, and thus the size of the balloon may be fixed, and the information displayed in the balloon may be changed by scrolling, batch switching of the display range, or the like. In this case, a form may be adopted in which the change is instructed by an operation on the input unit 74 provided on the AR glass 70, a gesture by the print instructor himself, or the like.

Further, the AR screen shown in FIG. 15 exemplifies a case where each of individual superimposed information is displayed separately for a plurality of sheets of printed matter, but the present invention is not limited to this. For example, a form may be adopted in which each piece of superimposed information is displayed collectively, or in a case where each printed matter cannot be identified, it is displayed collectively, in a case where each printed matter can be identified, it is displayed separately, or the print instructor instructs the switching of the display of the superimposed information in this form. In this case, a form may be adopted in which the switching instruction is also performed by an operation on the input unit 74 provided on the AR glass 70, a gesture by the print instructor himself, or the like.

### Second Exemplary Embodiment

In the present exemplary embodiment, a case where the technique of the present disclosure is configured to include a server as an information processing apparatus of the technique of the present disclosure, a terminal apparatus that instructs execution of printing, an image forming apparatus that performs the printing, and a VR goggles, and applied to an information processing system that realizes a VR environment will be described.

First, a configuration of an information processing system 1 according to the present exemplary embodiment will be described with reference to FIG. 16. FIG. 16 is a block diagram showing an example of a configuration of the information processing system 1 according to the present exemplary embodiment, and the same components as those in FIG. 1 are designated by the same reference numerals as those in FIG. 1, and the description thereof will be omitted.

As shown in FIG. 16, the information processing system 1 according to the present exemplary embodiment is different from the information processing system 1 according to the first exemplary embodiment in that the AR glass 70 is a VR goggles 80.

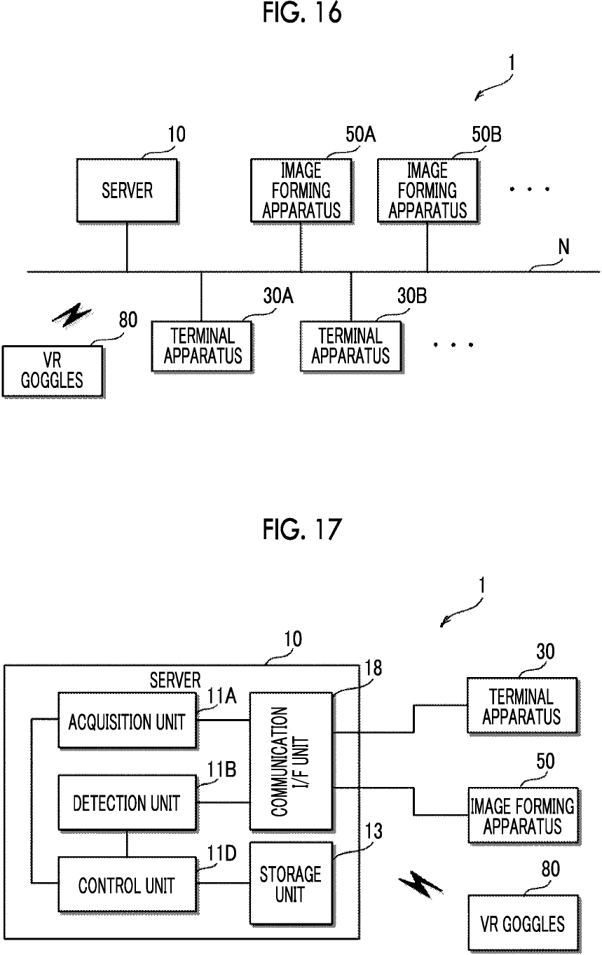

Next, with reference to FIG. 17, the functional configuration of the server 10 according to the present exemplary embodiment will be described. FIG. 17 is a block diagram showing an example of the functional configuration of the server 10 according to the present exemplary embodiment, and the same components as the components in FIG. 6 are designated by the same reference numerals as the components in FIG. 6, and the description thereof will be omitted.

As shown in FIG. 17, the server 10 according to the present exemplary embodiment is different from the server 10 according to the first exemplary embodiment in that a control unit 11D is applied instead of the control unit 11C.

That is, the control unit 11D according to the present exemplary embodiment is different from the control unit 11C according to the first exemplary embodiment in that the control unit 11D controls to virtually display the printed matter in addition to the superimposed information. By this control, the display of the superimposed information in the AR environment realized in the first exemplary embodiment can be realized in a VR environment as well.

For example, after instructing the image forming apparatus 50 to print the printed matter by using the terminal apparatus 30 in a real space, the print instructor causes the image forming apparatus 50 to print the printed matter, and the operation until the printed matter is taken out is executed in the same manner as in the first exemplary embodiment described above.

On the other hand, the image forming apparatus 50 is the same as the first exemplary embodiment in that, in a case where the print instructor designates the printed matter, the image forming apparatus 50 transmits the document specification information related to the printed matter to the server 10, but is different from the first exemplary embodiment in that the subsequent processing is processing for the VR goggles 80.

As a whole, the print instruction processing, information processing, print processing, and tracking processing described in the first exemplary embodiment are almost the same as those in the first exemplary embodiment except that the control target is changed from the AR glass 70 to the VR goggles 80. Therefore, further description will be omitted.

In each of the above exemplary embodiments, a case where the position of the target printed matter is defined as the coordinate position with the predetermined position in the three-dimensional space as the origin has been described, but the present invention is not limited to this. For example, a form may be adopted in which information indicating a relative position with respect to the position of an object that is stationary in the three-dimensional space is applied as the information indicating the position of the target printed matter.

Further, in each of the above exemplary embodiments, the timing of canceling the association between the target printed matter and the superimposed information is not mentioned. As this timing, a form is exemplified in which a timing at which it is detected that the target printed matter has been discarded by a shredder or the like is applied. In addition, a timing set by the user, such as a timing at which a predetermined time has elapsed, is also exemplified.

Further, in each of the above exemplary embodiments, in a case where a plurality of sheets of printed matter are printed at one time, a case where individual superimposed information is virtually superimposed and displayed on each printed matter has been described, but the present invention is limited to this. For example, a form may be adopted in which in a case where a plurality of printed matters are overlapped, only superimposed information corresponding to a first sheet of printed matter is displayed, and in a state where the plurality of printed matters are separated, individual superimposed information is displayed for each printed matter.

Further, in each of the above exemplary embodiments, a case where each superimposed information is applied to only a single user has been described, but the present invention is not limited to this. For example, a form may be adopted in which each superimposed information is shared and used by each of a plurality of users.

Further, in each of the above exemplary embodiments, a case where the AR glass 70 (VR goggles 80) and other apparatus are directly communicated with each other has been described, but the present invention is not limited thereto. For example, a form may be adopted in which the AR glass 70 (VR goggles 80) is communicated with other apparatus via a portable information processing apparatus such as a smartphone or tablet terminal owned by the user. In this case, a form may be adopted in which in a case where the login authentication is performed by fast identity online (FIDO) authentication or the like when using a portable information processing apparatus, the login authentication also serves as the login authentication performed by the image forming apparatus 50.

By making the login authentication performed by the image forming apparatus 50 the authentication by receiving the information from the portable information processing apparatus such as the FIDO authentication, and the like, the image forming apparatus 50 and the portable information processing apparatus are wirelessly coupled for the authentication. Therefore, the coupling can be used to continue the subsequent transmission of information to the AR glass 70 (VR goggles 80) via the image forming apparatus 50.

Further, in each of the above exemplary embodiments, in a case where the server 10 receives each piece of information of the title and the layout, a case where it is assumed that a plurality of corresponding printed matters are overlapped and the superimposed information is collectively associated with the corresponding printed matter as integrated information and stored has been described. In the form, a form may be adopted in which in a case where a plurality of corresponding printed matters are subsequently separated from each other, these superimposed information may be regarded as separate and may be individually associated with the corresponding printed matter.

Further, in each of the above exemplary embodiments, a case where various databases are registered in the server 10 has been described, but the present invention is not limited to this. For example, a form may be adopted in which various databases are registered in the terminal apparatus 30 used by an administrator of the information processing system 1 or the image forming apparatus 50 usually used.

Further, in each of the above exemplary embodiments, a case where the printed matter is detected to be separated from the image forming apparatus 50 by using the line-of-sight detection function provided in the AR glass 70 (VR goggles 80) has been described, but the present invention is limited to this. For example, a form may be adopted in which it is detected that the printed matter is separated from the image forming apparatus 50 by detecting that the title of the printed matter or a characteristic image is included in the photographed image by the photographing unit 77 provided in the AR glass 70 (VR goggles 80) by the OCR technique or the like. In this case, in a case where only one sheet of printed matter is printed, the AR glass 70 (VR goggles 80) has the superimposed information obtained from the server 10, so that a form may be adopted in which the printed matter is regarded as separated from the image forming apparatus 50 by detecting the information included in the superimposed information by the OCR technique or the like.

Although the exemplary embodiments have been described above, the technical scope of the present invention is not limited to the scope described in the above exemplary embodiments. Various changes or improvements may be made to each exemplary embodiment without departing from the gist of the present invention, and the changed or improved form is also included in the technical scope of the present invention.

Further, each of the above exemplary embodiments does not limit the invention according to the claim, and not all combinations of characteristics described in the exemplary embodiments are indispensable for the means for addressing the invention. The above-described exemplary embodiments include inventions at various stages, and various inventions are extracted by combining a plurality of disclosed constituents. Even in a case where some constituents are deleted from all the constituents shown in the exemplary embodiment, the configuration in which some of the constituents are deleted can be extracted as an invention as long as the effect is obtained.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

Further, in each of the above exemplary embodiments, a case where various processing is realized by a software configuration using a computer by executing a program has been described, but the present invention is not limited thereto. For example, a form may be adopted in which the various processing is realized by a hardware configuration or a combination of a hardware configuration and a software configuration.

In addition, the configurations of the server 10, the terminal apparatus 30, the image forming apparatus 50, and the AR glass 70 described in each of the above exemplary embodiments are examples, and unnecessary parts may be deleted or new parts may be added within a range that does not deviate from the gist of the present invention.

Further, the flows of various processing described in each of the above exemplary embodiments are also examples, needless to say, unnecessary steps may be deleted, new steps may be added, or the processing order may be changed without departing from the gist of the present invention.

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to:
in a case where a print instruction of a printed matter is issued to an image forming apparatus from an instruction apparatus, acquire superimposed information virtually superimposed and displayed on the printed matter; and
in a case where it is detected that the printed matter is printed by the image forming apparatus, perform control to store the superimposed information in a storage unit in association with the printed matter.

2. The information processing apparatus according to claim 1,
wherein the processor is configured to:
acquire the superimposed information by extracting the superimposed information from print job information used for printing the printed matter.

3. The information processing apparatus according to claim 2,
wherein the superimposed information includes at least one piece of information of a title, an author, and a creation date of the printed matter.

4. The information processing apparatus according to claim 1,
wherein the processor is configured to:
detect that the printed matter is printed by detecting that the printed matter is separated from the image forming apparatus.

5. The information processing apparatus according to claim 2,
wherein the processor is configured to:
detect that the printed matter is printed by detecting that the printed matter is separated from the image forming apparatus.

6. The information processing apparatus according to claim 3,
wherein the processor is configured to:
detect that the printed matter is printed by detecting that the printed matter is separated from the image forming apparatus.

7. The information processing apparatus according to claim 4,
wherein the processor is configured to:
detect that the printed matter is separated from the image forming apparatus by detecting that a line of sight of a printing person of the printed matter is directed at the printed matter.

8. The information processing apparatus according to claim 5,
wherein the processor is configured to:
detect that the printed matter is separated from the image forming apparatus by detecting that a line of sight of a printing person of the printed matter is directed at the printed matter.

9. The information processing apparatus according to claim 6,
wherein the processor is configured to:
detect that the printed matter is separated from the image forming apparatus by detecting that a line of sight of a printing person of the printed matter is directed at the printed matter.

10. The information processing apparatus according to claim 1,
wherein the processor is configured to:
in a case where a plurality of sheets of printed matter are printed and the printed plurality of sheets of printed matter are overlapped, perform control to create integrated information in which the superimposed information corresponding to each of the plurality of sheets of printed matter is integrated and to store the integrated information in the storage unit in association with the plurality of sheets of printed matter collectively.

11. The information processing apparatus according to claim 2, wherein the processor is configured to:
in a case where a plurality of sheets of printed matter are printed and the printed plurality of sheets of printed matter are overlapped, perform control to create integrated information in which the superimposed information corresponding to each of the plurality of sheets of printed matter is integrated and to store the integrated information in the storage unit in association with the plurality of sheets of printed matter collectively.

12. The information processing apparatus according to claim 3, wherein the processor is configured to:
in a case where a plurality of sheets of printed matter are printed and the printed plurality of sheets of printed matter are overlapped, perform control to create integrated information in which the superimposed information corresponding to each of the plurality of sheets of printed matter is integrated and to store the integrated information in the storage unit in association with the plurality of sheets of printed matter collectively.

13. The information processing apparatus according to claim 4, wherein the processor is configured to:
in a case where a plurality of sheets of printed matter are printed and the printed plurality of sheets of printed matter are overlapped, perform control to create integrated information in which the superimposed information corresponding to each of the plurality of sheets of printed matter is integrated and to store the integrated information in the storage unit in association with the plurality of sheets of printed matter collectively.

14. The information processing apparatus according to claim 5, wherein the processor is configured to:
in a case where a plurality of sheets of printed matter are printed and the printed plurality of sheets of printed matter are overlapped, perform control to create integrated information in which the superimposed information corresponding to each of the plurality of sheets of printed matter is integrated and to store the integrated information in the storage unit in association with the plurality of sheets of printed matter collectively.

15. The information processing apparatus according to claim 6, wherein the processor is configured to:
in a case where a plurality of sheets of printed matter are printed and the printed plurality of sheets of printed matter are overlapped, perform control to create integrated information in which the superimposed information corresponding to each of the plurality of sheets of printed matter is integrated and to store the integrated information in the storage unit in association with the plurality of sheets of printed matter collectively.

16. The information processing apparatus according to claim 7, wherein the processor is configured to:
in a case where a plurality of sheets of printed matter are printed and the printed plurality of sheets of printed matter are overlapped, perform control to create integrated information in which the superimposed information corresponding to each of the plurality of sheets of printed matter is integrated and to store the integrated information in the storage unit in association with the plurality of sheets of printed matter collectively.

17. The information processing apparatus according to claim 1, wherein the processor is configured to:
perform control to virtually display the printed matter in addition to the superimposed information.

18. The information processing apparatus according to claim 1, wherein the processor is configured to:
in a case where it is detected that the printed matter is printed by the image forming apparatus, acquire printing person information indicating a printing person who performed the printing from the image forming apparatus, and
specify the superimposed information to be superimposed on the printed matter by using the acquired printing person information.

19. A non-transitory computer readable medium storing an information processing program causing a computer to execute a process comprising:
acquiring, in a case where a print instruction of a printed matter is issued to an image forming apparatus from an instruction apparatus, superimposed information virtually superimposed and displayed on the printed matter; and
performing control, in a case where it is detected that the printed matter is printed by the image forming apparatus, to store the superimposed information in a storage unit in association with the printed matter.

20. An information processing method comprising:
acquiring, in a case where a print instruction of a printed matter is issued to an image forming apparatus from an instruction apparatus, superimposed information virtually superimposed and displayed on the printed matter; and
performing control, in a case where it is detected that the printed matter is printed by the image forming apparatus, to store the superimposed information in a storage unit in association with the printed matter.
